(19) United States
(12) Patent Application Publication
(10) Pub. No.: US 2009/0204793 A1
(43) Pub. Date: Aug. 13, 2009

(54) RAW Hazard Detection and Resolution for Implicitly Used Registers

(75) Inventors: Frank Lehnert, Stuttgart (DE); Guenter Gerwig, Simmozheim (DE); Karin Rebmann, Holzgerlingen (DE); Michael Cremer, Leonberg (DE); Ulrich Mayer, Weil im Schoenbuch (DE)

Correspondence Address: PRTSI, INC, 4661 CARISBROOKE LN, FAIRFAX, VA, 22030, US

(73) Assignee: INTERNATIONAL BUSINESS MACHINES CORPORATION, Armonk, NY (US)

(21) Appl. No.: 12/027,880

(22) Filed: Feb. 7, 2008

(51) Int. Cl. G06F 9/312

(52) U.S. Cl. 712/218; 712/E09.033

(57) ABSTRACT

The present invention provides a system, apparatus, and method for detecting and resolving read-after-write hazards encountered in processors following the dispatch of instructions requiring one or more implicit reads in a processor.

### SCOPE

The invention relates generally to processor systems having instruction formats supporting implicit register reads. It deals with the hardware and method for detection and resolution of possible RAW hazards caused by implicit reads in order to improve performance and reliability.

### BACKGROUND

In processor systems such as IBM's zseries processors (as described in the papers published in the IBM Journal of Research and Development, vol. 48, no. 3/4, May/July 2004 in pages 425-434 by L. C. Heller and M. S. Farrell entitled, “Millicode in an IBM zSeries Processor” and in pages 295-309 by T. J. Slegel, E. Pfeffer, and J. A. Magee, entitled “The IBM eServer z990 Microprocessor”) the code internal to the central processor is called millicode and the architecture is called z/architecture. Millicode resides in a protected area of storage called the hardware system area, which is not accessible to the normal operating system or application program. Millicode is handled by the processor hardware similarly to the way operating system code is handled.

One of the more important features of current processors, at least with regard to the millicode implementation, is the concept of a recovery unit (RU). This unit contains the entire architected state of the processor as well as the state of the internal controls of the processor. The RU includes the program general registers and access registers, millicode general registers and access registers, floating-point registers, architected control registers for multiple levels of Start Interpretive Execution (SIE) guests, architected timing facilities for multiple levels of SIE guests, information concerning the processor state, and information on the system configuration. In addition, there are registers which control the hardware execution, and data buses for passing information from the processor to the other chips within the processing complex.

For a subset of z/Architecture millicode instructions, two address modification facilities are provided. The modification is either applied to the source or the target address depending on whether the appropriate instruction reads or writes a RU register. Regardless of which kind of modification is applied, one additional millicode control register, MCR is not specified by the instruction itself must be read out. The process of reading an additional RU register not specified by the instruction itself is also called Implicit Read. Address modifications are allowed for certain instructions and how an address is changed depends on bits 16:17 of instruction text (ITXT).

Based on the ITXT bits 16 and 17, three different kinds of address modifications are done as shown in Table 1 below:

TABLE 1
Address Modifications

| ITXT | | |
|---|---|---|
| 16 | 17 | Address Modification |
| 0 | 0 | No Modification |
| 0 | 1 | Indirect Addressing Modification |
| 1 | 0 | SIE Emulation Adjust Modification |
| 1 | 1 | SIE Emulation Adjust Modification + Indirect Addressing |
| | | Modification |

In an SIE Emulation Adjust Modification, in a z/architecture processor, Bits 2:3 of the MCR address is replaced with the current SIE emulation level indicated by MCR43 (2:3). This feature is intended for use in accessing the ESA/390 and z/Architecture control registers and timing facility registers in a mode-independent manner.

In an Indirect Addressing Modification, in a z/architecture processor, MCR41 (4 8:55) is to be used as the MCR address instead of the address specified for the instruction.

In an SIE Emulation Adjust Modification+Indirect Addressing Modification, in a z/architecture processor, bits 2:3 of the value in MCR41 (48:55) are replaced by the encoded SIE level indicated by MCR43 (2:3) to form the effective MCR address.

A major problem for these kinds of instructions is the classical RAW (Read-After-Write) hazard since, for address modifications, either MCR41 or MCR43, or both, are implicitly read. If MCR41 or MCR43 is changed shortly before an instruction using address modifications is executed, the modification is done based on an old MCR value that may lead to unpredictable results. In the actual design, in general, it's the responsibility of millicode to insure that the MCR values used are stable (no updates are pending) at the time of use. Right now two mechanisms are provided in the hardware which millicode may use to restrict the pipelined processing of millicode instructions to ensure that events from different instructions happen in a fixed sequence. The first is the DRAIN instruction, which causes instruction decoding to stop until the conditions specified in the DRAIN operand are met. The second means available to millicode is to separate the execution of dependent millicode instructions by inserting millicode instructions in between. Giving millicode the possibility to control the data dependency resolution has some disadvantages in terms of reliability and performance. There are many places in different millicode listings where instructions using address modifications may be called. This means that for every single instance millicode must resolve possible data dependencies by using a DRAIN instruction or by inserting millicode instructions. If only one instance is not correctly resolved or just forgotten, instruction execution may produce unpredictable results. By using a DRAIN instruction for separating an instruction that writes either MCR41 or MCR43 from an instruction using address modifications may have performance impacts since decoding is stopped. Depending on which DRAIN is used, it can take quite a while until the DRAIN condition is met and instruction decoding proceeds. Inserting additional instructions to fill out the gap between two dependent instructions may have an impact on performance. Furthermore, millicode must know how many machine cycles the hardware requires for instruction executing in order to determine the exact number of instructions used for separating. Since the number of execution cycles can vary under certain circumstances (for example super-scalar) the number of instructions used for separation is often too pessimistic.

Due to the fact that register updates are made very late in the instruction pipeline and reads very early, a read referencing the same register as a preceding write does not get the updated value. This classical RAW (Read-After-Write) hazard is resolved for millicode instructions which are not using implicit reads such as used by the SIE Emulation or Indirect Addressing facility.

### SUMMARY

The invention provides for a system, apparatus, and method for detecting and resolving read-after-write hazards for implicit read instructions dispatched in a processor.

To detect impending writes to registers targeted by implicit reads, the system utilizes a write tracking queue. When an implicit read instruction is dispatched, a look-up of the write tracking queue is performed in parallel to the implicit read instruction execution.

Then, using the detection data from the write tracking queue look-up, either the implicit read instruction, corresponding to the detection of impending write update to the one or more registers to be read by the implicit read instruction, is rejected or if no detection of an impending write update to the one or more registers to be read by the implicit read instruction occurs, the implicit read instruction is executed.

When an implicit read instruction is rejected for the reason stated above, all instructions, following the rejected implicit read instruction are killed, until such a point in the processor's cycle when the processor begins a new sequence of instruction processing cycles. Then, the rejected instruction and the killed instructions that followed the rejected instruction are re-entered into the instruction stream and the process is repeated.

### DESCRIPTION OF DRAWINGS

FIG. 1 depicts the relationship of the writes to the reads in a pipelined register and the rejection of instructions for a read-after-write hazard according to the invention.

FIG. 2 depicts the RAW pipeline structure including a subset of two pipelines making up the write tracking queue for the registers MCR41 and MCR43.

### DETAILED DESCRIPTION OF THE INVENTION

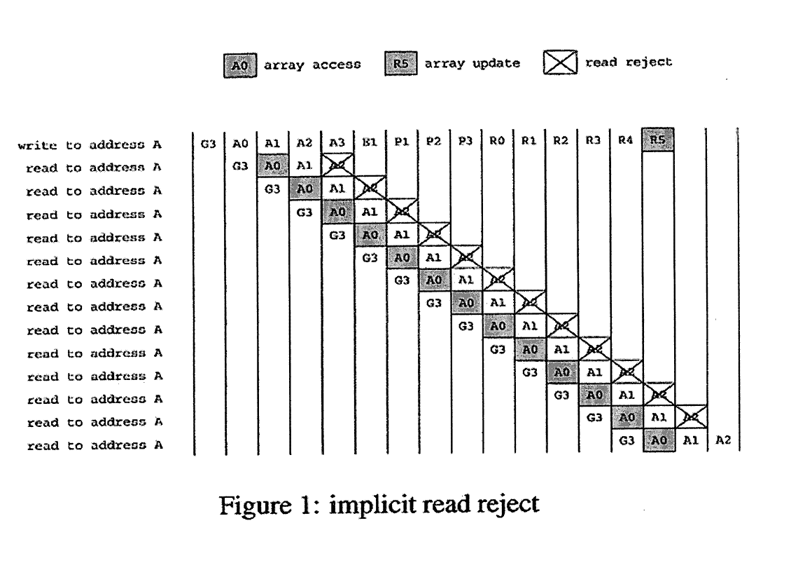

The invention provides a RAW interlock mechanism which can now also detect interactions between a write that updates either MCR41 or MCR43 and a succeeding implicit read caused by one of the two address modification facilities. After an instruction that writes MCR41 or MCR43, couple instructions, using address modifications, can be dispatched which are not getting the updated MCR values. Referencing FIG. 1, one can see that the exact instruction number is determined by the instruction pipeline itself. Since register writes are done in R5 and register reads are done in A0, an instruction that is dispatched within the next 12 cycles after a write instruction and uses address modifications gets rejected. The first pipeline slot where an instruction that has active ITXT bits 16:17 can make address modifications based on the updated MCR is in the 13th cycle after the write instruction dispatch.

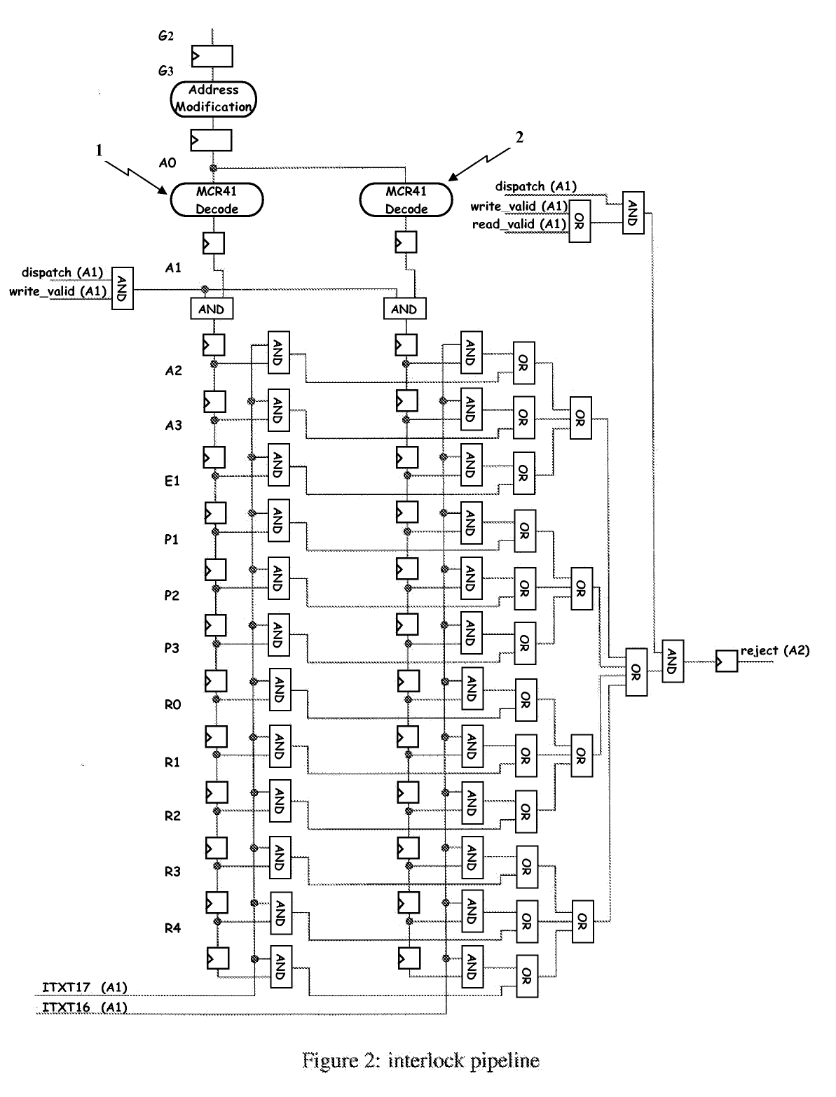

In order to detect and resolve true data dependencies caused by implicit reads in hardware, a pipeline structure is needed that tracks writes to specific registers. For implicit reads caused by address modifications to be detected and resolved, the write queue is subdivided into two single pipelines, 1 and 2, as shown in FIG. 2. Pipeline 1 tracks writes to MCR41 used for Indirect Addressing, while pipeline 2 tracks writes to MCR43 used for SIE Emulation. The appropriate pipeline length can be directly derived from the instruction pipeline. Hardware must ensure that reads dispatched within the twelve cycle window get rejected. With that in mind the two pipelines must have twelve stages corresponding to A1-R4 of the write pipeline. Whenever an instruction is dispatched that requires an implicit read, a lookup in either one of the two pipelines or in both is made in order to find out whether a MCR41/MCR43 update is on its way through the write pipeline to get updated. If yes, the instruction using the implicit read gets rejected, and, if not, instruction execution proceeds. Once an instruction is rejected, the rejected instruction itself and all following instructions are killed. Instruction execution resumes nine cycles later by dispatching the rejected instruction again. Depending in which cycle an instruction that requires an implicit read relative to a MCR41/MCR43 write is dispatched, the instruction can be rejected up to two times.

While the invention has been described in a z/architecture pipeline with the implicit read potentially affecting two specific registers, the invention is not limited to a specific number of registers which may be affected by implicit reads. Also, the tracking mechanism is not limited to a pipeline structure as shown in the embodiment of FIG. 2, but may be any detection and storage means which may later be looked up.

What is claimed:

1. A method of detecting and resolving read-after-write hazards for instructions dispatched in a processor requiring one or more implicit reads, comprising:
using a write tracking queue for tracking writes to one or more registers to be implicitly read when one or more instructions requiring at least one implicit read are executed;
detecting, in parallel to the execution of the one or more instructions requiring at least one implicit read, whether the one or more registers, to be implicitly read have an impending write update, by looking up the write tracking queue
using the detection data from the write tracking queue look-up and either rejecting the one or more instructions that require at least one implicit read corresponding to the detection of an impending write update to the one or more registers to be implicitly read or proceeding with the execution of the one or more instructions that requires at least one implicit read, corresponding to no detection of an impending write update to the one or more registers to be implicitly read;
killing all instructions, following any rejected instruction; and
executing the rejected one or more instructions and the killed instructions that follow the one or more rejected instructions, said execution coinciding with the beginning of a next set of cycles used by the processor to process instructions.
